(19) United States
(12) Patent Application Publication
(10) Pub. No.: US 2009/0230601 A1
(43) Pub. Date: Sep. 17, 2009

(54) Biaxial Exhaust Isolator With Dual-Band Reinforcement

(75) Inventor: Daniel J. Lenda, Farmington Hills, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/048,459

(22) Filed: Mar. 14, 2008

(51) Int. Cl. F16F 7/00; B60K 13/04

(52) U.S. Cl. 267/141.1; 180/89.2

(57) ABSTRACT

A biaxial exhaust isolator for preventing transmission of vibrations between a motor vehicle and an exhaust system is provided. The exhaust isolator includes an elastomeric body with a body-side portion defining a first channel configured to receive and retain a support rod extending from the vehicle underbody. The elastomeric body also has an exhaust-side portion, adjacent the body-side portion, that defines a second channel configured to receive and retain a hanger rod attached to one of the exhaust system components. The first channel has a first longitudinal axis, whereas the second channel has a second longitudinal axis that is offset from and nonparallel to the first longitudinal axis. A first rigid band is integrated within the body-side portion, extending continuously about and generally coaxial with the first channel. A second rigid band is integrated within the exhaust-side portion, extending continuously about and generally coaxial with the second channel.

### TECHNICAL FIELD

The present invention relates generally to exhaust systems for motorized vehicles, and more specifically to mounting devices for vehicle exhaust systems that provide vibration isolation between the exhaust system and the vehicle, while maintaining sufficient durability throughout the operational life of the exhaust system.

### BACKGROUND OF THE INVENTION

Almost all modern automotive vehicles include an exhaust system for mitigating the byproducts generated from operation of the internal combustion engine. Most exhaust systems include a catalytic converter or similar exhaust aftertreatment device for reducing the toxicity of exhaust gas emissions, a muffler assembly or similar device for attenuating noise generated by the exhaust emission process, and an exhaust pipe or conduit to route the byproducts of combustion away from the engine. The aftertreatment device is normally placed between the engine exhaust manifold and the muffler of the automobile, but can also be integrated into the muffler assembly itself.

The exhaust system is normally suspended by a number of exhaust mounts that are positioned at various points along the length of the system, between the constituent components of the exhaust system and the frame or other supporting structure of the vehicle body. Conventional exhaust mounts include, for example, a first bracket attached at one end to the underbody frame of the vehicle, and attached at another end to a second bracket that is coupled to the component being supported. Some exhaust mounts employ flexible mounting brackets or elastic suspension hangers to prevent vibrations from being transmitted to and from the vehicle body.

### SUMMARY OF THE INVENTION

According to one embodiment of the present invention, an exhaust isolator for preventing the transmission of vibrations between a vehicle and an exhaust system is provided. The vehicle has one or more support rods extending therefrom, and the exhaust system has one or more hanger rods attached thereto. The exhaust isolator includes an elastic body with a body-side portion which defines a first channel that is configured to receive a support rod. The elastic body also has an exhaust-side portion which defines a second channel that is configured to receive a hanger rod. The first channel has a first longitudinal axis, whereas the second channel has a second longitudinal axis that is nonparallel to the first longitudinal axis. Ideally, the first longitudinal axis is substantially perpendicular to the second longitudinal axis.

A first rigid band member is attached to the body-side portion, extending about the first channel. A second rigid band member is attached to the exhaust-side portion, extending about the second channel. The first and second band members allow use of a softer material for the elastic body (e.g., a lower durometer rubber), while maintaining sufficient durability throughout the operational life of the exhaust system. Accordingly, an exhaust isolator according to the present invention provides enhanced noise, vibration, and harshness (NVH) performance, and superior strength and resiliency.

According to one aspect of the first embodiment, the first rigid band member is rigidly attached to the second rigid band member at a peripheral surface thereof. Notably, the first and second rigid band members may be fabricated from a variety of materials. Such materials include, but are not limited to, metallic materials, plastic composites, and fiber-reinforced polymers.

According to another aspect of the first embodiment, the first rigid band member is integrated within the body-side portion of the elastic body. Similarly, the second rigid band member is preferably integrated within the exhaust-side portion of the elastic body.

In accordance with another aspect, the first rigid band member extends continuously about and generally coaxial with the first channel. In a similar respect, the second rigid band member preferably extends continuously about and generally coaxial with the second channel.

According to yet another aspect of the first embodiment, one or both of the rigid band members defines at least one perforation that is configured to provide a mechanical bond between that rigid band member and the elastic body.

According to another embodiment of the present invention, an exhaust system isolator for preventing transmission of vibrations between a motorized vehicle and an exhaust system is presented. The vehicle has a vehicle underbody with at least one support rod extending therefrom, while the exhaust system includes an exhaust component with a hanger rod operatively attached thereto. The exhaust system isolator includes an elastomeric body with a body-side portion adjacent an exhaust-side portion. The body-side portion defines a first channel therethrough that is configured to receive and retain one of the support rods. The exhaust-side portion defines a second channel therethrough that is configured to receive and retain the hanger rod. The first channel has a first longitudinal axis, and the second channel has a second longitudinal axis that is offset from and substantially perpendicular to the first longitudinal axis. In addition, a first rigid band member is integrated within the body-side portion of the elastomeric body, extending continuously about and generally coaxial with the first channel. Moreover, a second rigid band member is integrated within the exhaust-side portion of the elastomeric body, extending continuously about and generally coaxial with the second channel.

In accordance with yet another embodiment of the present invention, an exhaust system for a motorized vehicle is provided. The exhaust system includes an exhaust component with a hanger rod operatively attached thereto. The exhaust component may consist of an exhaust pipe, an exhaust aftertreatment device, a resonator device, and/or a muffler device. The exhaust system also includes one or more exhaust system isolators, each configured to prevent transmission of vibrations between the exhaust component and the motorized vehicle.

Each exhaust system isolator includes an elastomeric body with an exhaust-side portion vertically adjacent a body-side portion. The body-side portion defines a first channel therethrough that is configured to receive and retain a support rod extending from the vehicle underbody. The exhaust-side portion defines a second channel therethrough that is configured to receive and retain the hanger rod. The first channel has a first longitudinal axis, and the second channel has a second longitudinal axis that is offset from and substantially perpendicular to the first longitudinal axis.

Each isolator also includes a first rigid band member that is integrated within the body-side portion of the elastomeric body, encircling and substantially coaxial with the first channel. A second rigid band member is integrated within the exhaust-side portion of the elastomeric body, encircling and substantially coaxial with the second channel. The first rigid band member is rigidly attached to the second rigid band member along an outer peripheral surface thereof.

The above features and advantages, and other features and advantages of the present invention will be readily apparent from the following detailed description of the preferred embodiments and best modes for carrying out the invention when taken in connection with the accompanying drawings and appended claims.

### BRIEF DESCRIPTION OF THE DRAWINGS

FIG. 1A is a perspective view illustration of an exemplary vehicle exhaust system employing a plurality of biaxial exhaust isolators in accordance with the present invention;

FIG. 1B is an enlarged perspective view illustration of a portion of the exhaust system and the biaxial exhaust isolators of FIG. 1A;

FIG. 2A is a perspective view illustration of a biaxial exhaust isolator in accordance with the present invention;

FIG. 2B is a perspective view in cross-section of the biaxial exhaust isolator of FIG. 2A taken along line 1-1 illustrating a dual-band substrate integrated therein; and

FIG. 2C is a perspective view illustration of the dual-band substrate.

### DESCRIPTION OF THE PREFERRED EMBODIMENTS

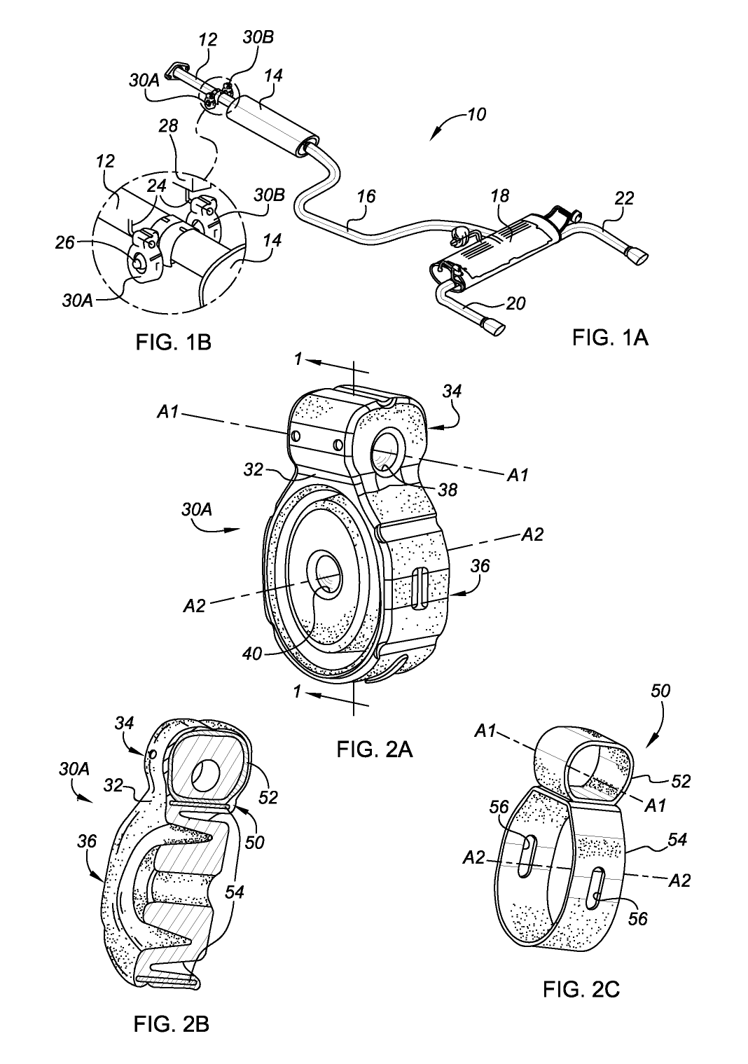

Referring to the drawings, wherein like reference numbers refer to like components throughout the several views, there is shown in FIG. 1A a representative vehicle exhaust system, identified generally at 10, utilizing a plurality of biaxial exhaust isolators (also referred to herein as “exhaust isolator” and “exhaust system isolator”) in accordance with the present invention. The present invention is described herein with respect to the exhaust system 10 of FIG. 1A, which is intended solely as an exemplary application by which the present invention may be incorporated or practiced. As such, the present invention is by no means limited to the particular configuration or structure of FIGS. 1A-1B. In addition, the drawings presented herein—i.e., FIGS. 1A through 2C, are not to scale and are provided purely for instructional purposes. Thus, the specific and relative dimensions shown in the drawings are not to be considered limiting.

The exhaust system 10 is utilized to route exhaust gasses from an engine (e.g., an internal combustion engine) to the rear area of a motorized vehicle. The exhaust system 10 is shown in FIG. 1A as including a first intermediate exhaust pipe or conduit 12 attached at one end to a resonator 14. First intermediate exhaust pipe 12 is typically connected at an opposing end to a catalytic converter or other exhaust aftertreatment device (not shown), which is fluidly coupled, in turn, to an exhaust manifold (not shown) of the vehicle's engine. A muffler or silencer 18 is downstream from and fluidly communicated with the resonator 14 via a second intermediate exhaust pipe or conduit 16. First and second tailpipes 20 and 22 protrude out of laterally opposing sides of the muffler 16. Recognizably, the exhaust system 10 may include additional or fewer intermediate pipes that fluidly couple one or more catalytic converters, any number of mufflers, a single or multiple tailpipes, or any combination thereof without departing from the intended scope of the present invention.

A plurality of exhaust system isolators, represented in part by first and second biaxial exhaust isolators 30A and 30B, respectively, provide superior alignment capabilities during the assembly of exhaust system 10, and operate to prevent the transmission of vibrations to and from the exhaust system 10. As will be understood from the following description, a biaxial exhaust isolator in accordance with the present invention—e.g., exhaust isolators 30A and 30B, offer enhanced NVH performance and superior strength and resiliency throughout the operational life of the exhaust system 10. Moreover, the exhaust isolators 30A and 30B according to the present invention can be used to support and isolate assorted exhaust system components, components of varying geometries, configurations, and sizes without departing from the intended scope of the claimed invention. Finally, the first and second exhaust isolators 30A, 30B are structurally identical. As such, for brevity and clarity, both exhaust isolators 30A, 30B will be described herein with respect to the first exhaust isolator 30A.

Looking at FIG. 2A, the exhaust system isolator 30A includes an elastomeric (or elastic) body 32 with a body-side portion or interface, indicated generally at 34, vertically adjacent to an exhaust-side portion or interface, indicated generally at 36. The elastomeric body 32 can be fabricated from silicone (for high temperature applications), ethylene-propylene-diene monomer (EPDM—for moderate temperature applications), rubber (for low temperature applications), or any other elastic material sufficient for the intended application of the exhaust isolator 30A.

The body-side portion 34 of the elastomeric body 32 defines a first channel 38 therethrough that is configured (i.e., dimensioned and contoured) to receive and retain a support rod 24 (seen in FIG. 1B) extending from the motorized vehicle, preferably from a portion of the vehicle underbody structure 28. The exhaust-side portion 36, as seen in FIG. 2A, defines a second channel 40 therethrough that is configured to receive and retain a hanger rod 26 (FIG. 1B) that is operatively attached (e.g., welded, coupled, integrally formed, etc.) to an exhaust component, as seen in FIG. 1B. As noted above, and shown in FIG. 1A, the exhaust component may consist of an exhaust pipe (e.g., intermediate exhaust pipes 12 and 16 or tailpipes 20 and 22), an exhaust aftertreatment device (e.g., a catalytic converter), a resonator device (e.g., resonator 14), and/or a muffler device (e.g., muffler 18). The first channel 38 has a first longitudinal axis A1, whereas the second channel 40 has a second longitudinal axis A2 that is nonparallel to the first longitudinal axis A1—hence the “biaxial” configuration of the exhaust isolator 30A. As shown throughout the drawings, the first longitudinal axis A1 is ideally offset from and substantially perpendicular to the second longitudinal axis A2.

The biaxial exhaust isolator 30A also includes a biaxial dual-band substrate, indicated generally by reference numeral 50 in FIGS. 2B and 2C. The dual-band substrate 50 consists essentially of first and second toroidal, rigid band members 52 and 54, respectively. The first and second rigid band members 52, 54 are preferably preformed, single-piece, substantially circular members, each constructed from a material known to have a suitable strength for the intended use of the exhaust isolator 30A, such as, but not limited to, high strength plastics (e.g., polyurethane, polyvinyl chloride, and polyethylene), metallic materials (e.g., steel or aluminum), fiber-reinforced polymers, etc. It is also within the scope of the present invention that the first and second rigid band members 52, 54 individually or collectively take on additional functional shapes (e.g., rectangular, elliptical, pentagonal, etc.) without departing from the scope of the present invention.

FIG. 2B of the drawings is a perspective view in cross-section of the biaxial exhaust isolator 30A of FIG. 2A, taken along line 1-1, illustrating the dual-band substrate 50 integrated therein. Specifically, the first rigid band member 52 is operatively attached to (e.g., integrated within) the body-side portion 34 of the elastomeric body 32. Ideally, the first rigid band member 52 extends about, preferably encircling in a substantially coaxial manner, the first channel 38. The second rigid band member 54 is operatively attached to (e.g., integrated within) the exhaust-side portion 36 of the elastomeric body 32. Similar to the first rigid band member 52, the second rigid band member 54 extends about, preferably encircling in a substantially coaxial manner, the second channel 40. Desirably, the first rigid band member 52 is rigidly and securely attached to the second rigid band member 54 along an outer peripheral surface thereof. The dual-band substrate 50—i.e., first and second band members 52, 54, allow use of a softer material for the elastic body 32 (e.g., a lower durometer rubber), while maintaining sufficient durability throughout the operational life of the exhaust system 10.

As seen in FIG. 2C, the second rigid band member 54 defines at least one, but preferably two perforations 56 at opposing locations about its circumference. Each perforation 56 is configured to provide a mechanical bond between the rigid band member 54 and the elastic body 32. For example, if the biaxial exhaust isolator 30A is formed by injecting a molten elastomer, such as rubber, into a mold within which the dual-band substrate 50 is suspended, the perforations 56 allow the molten elastomer to flow through the rigid band member 54 during the molding process, thus providing for a mechanical bond between the rigid band member 54 and the elastic body 32 once the rubber has solidified.

While the best modes for carrying out the present invention have been described in detail, those familiar with the art to which this invention relates will recognize various alternative designs and embodiments for practicing the invention within the scope of the appended claims.

1. An exhaust isolator for preventing transmission of vibrations between a vehicle having at least one support rod extending therefrom, and an exhaust system with at least one hanger rod operatively attached thereto, the exhaust isolator comprising:
an elastic body with a body-side portion defining a first channel that is configured to receive the at least one support rod, and an exhaust-side portion defining a second channel that is configured to receive the at least one hanger rod, said first channel having a first longitudinal axis, and said second channel having a second longitudinal axis that is nonparallel to said first longitudinal axis;
a first rigid band member operatively attached to said body-side portion and extending about said first channel; and
a second rigid band member operatively attached to said exhaust-side portion and extending about said second channel.

2. The exhaust isolator of claim 1, wherein said first longitudinal axis is substantially perpendicular to said second longitudinal axis.

3. The exhaust isolator of claim 1, wherein said first rigid band member is rigidly attached to said second rigid band member at a peripheral surface thereof.

4. The exhaust isolator of claim 1, wherein said first rigid band member is integrated within said body-side portion of said elastic body.

5. The exhaust isolator of claim 1, wherein said second rigid band member is integrated within said exhaust-side portion of said elastic body.

6. The exhaust isolator of claim 1, wherein said first rigid band member extends continuously about and generally coaxial with said first channel.

7. The exhaust isolator of claim 1, wherein said second rigid band member extends continuously about and generally coaxial with said second channel.

8. The exhaust isolator of claim 1, wherein said first and second rigid band members are fabricated from a metallic material.

9. The exhaust isolator of claim 1, wherein said first and second rigid band members are fabricated from a plastic composite.

10. The exhaust isolator of claim 1, wherein said first and second rigid band members are fabricated from a fiber-reinforced polymer.

11. The exhaust isolator of claim 1, wherein at least one of said first and second rigid band members defines at least one perforation configured to provide a mechanical bond between said at least one rigid band member and said elastic body.

12. An exhaust system isolator for preventing transmission of vibrations between a motorized vehicle having a vehicle underbody with at least one support rod extending therefrom, and an exhaust system including an exhaust component with a hanger rod operatively attached thereto, the exhaust system isolator comprising:
an elastomeric body with a body-side portion defining a first channel therethrough that is configured to receive and retain the at least one support rod, and an exhaust-side portion adjacent said body-side portion and defining a second channel therethrough that is configured to receive and retain the hanger rod, said first channel having a first longitudinal axis, and said second channel having a second longitudinal axis that is offset from and substantially perpendicular to said first longitudinal axis;
a first rigid band member integrated within said body-side portion and extending continuously about and generally coaxial with said first channel; and
a second rigid band member integrated within said exhaust-side portion and extending continuously about and generally coaxial with said second channel.

13. The exhaust system isolator of claim 12, wherein said first rigid band member is secured to said second rigid band member along an outer peripheral surface thereof.

14. The exhaust system isolator of claim 13, wherein said first and second rigid band members are each fabricated from at least one of a metallic material, a plastic composite, and a fiber-reinforced polymer.

15. The exhaust system isolator of claim 14, wherein at least one of said first and second rigid band members defines at least one perforation configured to provide a mechanical bond between said at least one rigid band member and said elastomeric body.

16. An exhaust system for a motorized vehicle having a vehicle underbody with at least one support rod extending therefrom, comprising:
an exhaust component with a hanger rod operatively attached thereto, said exhaust component including at least one of an exhaust pipe, an exhaust aftertreatment device, a resonator device, and a muffler device; and
at least one exhaust system isolator configured to prevent transmission of vibrations between said exhaust component and the motorized vehicle, including:
an elastomeric body with a body-side portion defining a first channel therethrough that is configured to receive and retain the at least one support rod, and an exhaust-side portion vertically adjacent said body-side portion and defining a second channel therethrough that is configured to receive and retain said hanger rod, said first channel having a first longitudinal axis, and said second channel having a second longitudinal axis that is offset from and substantially perpendicular to said first longitudinal axis;
a first rigid band member integrated within said body-side portion, and encircling and substantially coaxial with said first channel; and
a second rigid band member integrated within said exhaust-side portion, and encircling and substantially coaxial with said second channel;
wherein said first rigid band member is rigidly attached to said second rigid band member along an outer peripheral surface thereof.
